(19) United States
(12) Patent Application Publication
(10) Pub. No.: US 2026/0346831 A1
(43) Pub. Date: Nov. 5, 2026

(54) Electro-thermal cooperative control method, system and Energy-Hub for electric vehicle

(71) Applicant: XI'AN JIAOTONG UNIVERSITY, Xi'an, Shaanxi (CN)

(72) Inventors: Feng Cao, Xi'an, Shaanxi (CN); Yulong Song, Xi'an, Shaanxi (CN); Xiang Yin, Xi'an, Shaanxi (CN); Wenyi Wang, Xi'an, Shaanxi (CN); Xu Yang, Xi'an, Shaanxi (CN); Ce Cui, Xi'an, Shaanxi (CN); Shuo Zong, Xi'an, Shaanxi (CN)

(21) Appl. No.: 19/486,881

(22) PCT Filed: Apr. 19, 2024
(86) PCT No.: PCT/CN2024/088803

§ 371 Date: Nov. 21, 2025

(30) Foreign Application Priority Data
Jun. 5, 2023 (CN) 202310658199.6

(51) Int. Cl. B60W 10/26; B60H 1/00; B60L 1/00; B60L 1/02; B60L 58/12

(52) U.S. Cl. CPC B60W 10/26; B60H 1/0073; B60L 1/003; B60L 1/02; B60L 58/12; B60L 2240/34; B60L 2240/545

(57) ABSTRACT

The present invention relates to the technical field of electric vehicle energy integrated management. Disclosed are an electrothermal collaborative control method and system for an electric vehicle, and an energy router. The method comprises the following steps: acquiring operating state parameters of an electrical system device and a thermal system device of an electric vehicle; and according to the acquired operating state parameters, using a leader-follower Stackelberg game strategy to obtain operating parameters at the next moment of the electrical system device and the thermal system device, so as to realize electrothermal collaborative control of the electric vehicle. According to the technical solution provided by the present invention, a game theory is used to optimize energy management, so that electrothermal collaborative energy management can be carried out on the electric vehicle; the electrothermal collaborative management takes into account overall optimization and local optimization of vehicle energy configuration, thereby improving the vehicle performance.

### BACKGROUND OF THE PRESENT INVENTION

### Field of Invention

The present invention relates to a technical field of integrated energy management for electric vehicles, and more particularly to an electro-thermal cooperative control method, system and Energy-Hub for an electric vehicle.

### Description of Related Arts

New energy vehicles such as electric vehicles are cleaner and more eco-friendly than traditional fuel vehicles, whose ownership has been increasing in recent years.

Conventionally, electric vehicles still suffer from the technical problem of inefficient energy distribution, wherein each component tends to operate at its own maximum capacity, and there is no control algorithm that can be adapted to different vehicle operating situations, which results in a shorter endurance and hinders the promotion and development of electric vehicles.

Under the guidance of “Carbon Neutrality and Carbon Peaking”, various industries are in urgent need of an energy supply method that is more eco-friendly and energy-saving. As a result, electric vehicles need to optimize internal energy management and adopt more accurate and intelligent energy management methods to reduce energy waste and improve energy utilization, so as to alleviate range anxiety.

Thermal management of electric vehicles mainly covers power batteries, motor electric control, and passenger cabin, and electrical management mainly covers power batteries, motor electric control, and other electric equipment. Among them, thermal management ensures optimal working temperatures of functional components as well as temperature control of passenger cabin, and it is also designed to avoid the safety risks caused by thermal runaway of batteries and motors. Electricity management ensures that the vehicle starts and drives, the battery charges and discharges, and the air conditioner is powered. Both thermal management and electricity management are essential. Most of the conventional technologies put emphasis on either thermal management or electrical management, which can only realize the local optimal performance of the equipment and improve the thermal energy utilization efficiency or electrical energy utilization efficiency. However, it is not necessarily optimal for the overall performance of the electric vehicle.

### SUMMARY OF THE PRESENT INVENTION

An object of the present invention is to provide an electro-thermal cooperative control method, system and Energy-Hub for an electric vehicle, thereby solving one or more of the above technical problems. The present invention optimizes energy management using game theory, which enables electro-thermal cooperative energy management of the electric vehicle. With electro-thermal cooperative management, both the overall and local optimizations of vehicle energy allocation are considered, so as to improve the performance of the entire vehicle.

Accordingly, in order to accomplish the above objects, the present invention provides:
an electro-thermal cooperative control method for an electric vehicle, comprising steps of:
acquiring operating state parameters of electric system equipment and thermal system equipment of the electric vehicle; and
according to the operating state parameters, adopting Stackelberg competition to obtain next moment operating parameters of the electric system equipment and the thermal system equipment, so as to realize electro-thermal cooperative control of the electric vehicle;
wherein in the Stackelberg competition, a vehicle energy management system is a leader; and a passenger cabin, a battery and an air conditioning heat pump are followers; the vehicle energy management system sends an optimization strategy to the followers in accordance with an objective function of the vehicle energy management system; the followers make decisions in accordance with the optimization strategy sent by the leader, wherein the optimization strategy sent by the leader is used as a constraint, and the followers calculate an optimized strategy according to objective functions of the followers; the optimized strategy is then fed back to the leader; when Stackelberg equilibrium is reached after iterations, the leader and the followers obtain an optimal strategy, so as to obtain the next moment operating parameters of the electric system equipment and the thermal system equipment.

Preferably, in the step of acquiring the operating state parameters of the electric system equipment and the thermal system equipment of the electric vehicle:
the electric system equipment comprises the battery, a motor, and an electronic controller; and
the thermal system equipment comprises the air conditioning heat pump, a PTC (positive-temperature-coefficient) electric heater, an electronic fan, a blower, a water pump, and a motor electric waste heat recovery device.

Preferably, in the step of according to the operating state parameters, adopting the Stackelberg competition to obtain the next moment operating parameters of the electric system equipment and the thermal system equipment:
the Stackelberg competition is adopted to obtain the next moment operating parameters comprising battery charging and discharging powers, a motor power consumption, an air conditioning power consumption, an electric heating PTC power consumption, a blower power consumption, an electronic fan power consumption, a water pump power consumption, a battery temperature curve, and a passenger cabin temperature curve.

Preferably, the step of according to the operating state parameters, adopting the Stackelberg competition to obtain the next moment operating parameters of the electric system equipment and the thermal system equipment, so as to realize the electro-thermal cooperative control of the electric vehicle, comprises specific steps of:
calculating an initial value of the objective function of the vehicle energy management system, and initializing power and temperature populations using an NSGA (Non-dominated Sorting Genetic Algorithm) II algorithm;
selecting the power and temperature populations by the leader and sending the optimization strategy to the followers; calculating optimized strategy sets according to the objective functions of the followers, and selecting an optimal solution from the optimal strategy sets by using a TOPSIS (Technique for Order of Preference by Similarity to Ideal Solution) method, and then feeding the optimized strategy back to the leader; after reaching the Stackelberg equilibrium, calculating the objective function of the vehicle energy management system Iₑᵣ (i); processing the power and temperature populations with binary crossing and mutation operations, and obtaining a new generation of populations by an elite strategy; and
optimizing the Stackelberg competition again, and calculating a new objective function of the vehicle energy management system Iₑᵣ (i+1); if Iₑᵣ (i+1)>Iₑᵣ (i), then updating the populations, otherwise keeping the populations unchanged; then determining whether the Stackelberg equilibrium is reached; if yes, outputting results, otherwise repeating the iterations;
wherein the objective function of the vehicle energy management system is expressed as:

$$max {I}_{er} = min {\sum }_{t}^{T} S ( {P}_{bat , disch}^{t} - {T}_{bat}^{t} , v , {η}_{bat} ) Δ t ;$$

wherein Iₑᵣ is a range indicator of the electric vehicle, S is a driving range,

$${P}_{bat , disch}^{t}$$

is a battery output power,

$${T}_{bat}^{t}$$

is a battery temperature, v is a vehicle speed, η_{bat} is a battery working efficiency, Δt is a preset time interval, and T is a scheduling cycle.

Preferably, a passenger cabin objective function I_{cabin} in the objective functions of the followers is expressed as:

$$min {I}_{cabin} = min {\sum }_{t}^{T} {φ}_{cabin} ( {T}_{cabin}^{t} - {T}_{cabin , set} ) + {{ϕ}_{cabin} ( {T}_{cabin}^{t} - {T}_{cabin , set} )}^{2} Δ t ;$$

wherein T_{cabin} is a real-time passenger cabin temperature and t denotes time; T_{cabin,set} is an optimal thermal comfort temperature; φ_{cabin} and φ_{cabin} are a temperature deviation coefficient and a temperature fluctuation coefficient, respectively;
wherein when thermal comfort PMV (Predicted Mean Vote) is close to 0, then a temperature is more comforting, and the PMV for the optimal thermal comfort temperature of the passenger cabin is 0, which is expressed as:

$${T}_{cabin , set} = {t}_{a} {\vert}_{PMV = 0} ;$$

$$PMV = [ 0.303 {e}^{- 0.036 M} + 0.028 ] \times \{ M - W - ( {φ}_{1} + {φ}_{2} + {φ}_{3} + {φ}_{4} + {φ}_{5} + {φ}_{6} ) ;$$

$$\{ \begin{matrix}{φ}_{1} = 3.05 \times [ 5.733 − 0.007 ( M − W ) − {P}_{a} \\ {φ}_{2} = − 0.42 ( M − W − 58.2 ) \\ {φ}_{3} = 0.017 M ( 5.867 − {P}_{a} ) \\ {φ}_{4} = 0.0014 M ( 34 − {t}_{a} ) \\ {φ}_{5} = 3.96 \times {10}^{− 8} {f}_{cl} [ {( {t}_{cl} + 273 )}^{4} − {( {\overline{t}}_{r} + 273 )}^{4} ] \\ {φ}_{6} = {f}_{cl} {h}_{c} ( {t}_{cl} − {t}_{a} ) \\ {t}_{cl} = 35.7 − 0.028 ⋆ ( M − W ) − 0.155 {I}_{cl} ( {φ}_{5} + {φ}_{6} )\end{matrix} ;$$

wherein tₐ is an air temperature around a passenger, Mis an energy metabolic rate of the passenger, W is a mechanical work done by the passenger, t_{cl} is a surface temperature of clothing, t̅ᵣ̅ is an average radiant temperature in the passenger cabin, Pₐ is a partial pressure of water vapor around the passenger, h_{c} is a convective heat transfer coefficient, ƒ_{cl} is a clothing area coefficient, and I_{cl} is a clothing thermal resistance.

Preferably, a battery objective function I_{bat} in the objective functions of the followers is expressed as:

$$max {I}_{bat} = max {\sum }_{t}^{T} [ {a}_{1} {f}_{η} ( {T}_{bat}^{t} ) − {a}_{2} {P}_{bat , disch}^{t} ] Δ t ;$$

wherein ƒ_{η} is a battery efficiency function,

$${P}_{bat , disch}^{t}$$

is the battery output power, a₁ and a₂ are weighting coefficients;
wherein an equipment condition constraint for the battery is expressed as:

$$\{ \begin{matrix}{T}_{bat , min} \leq {T}_{bat}^{t} \leq {T}_{bat , max} \\ {SOC}_{bat , min} \leq {SOC}_{bat}^{t} \leq {SOC}_{bat , max} \\ {P}_{bat , disch}^{t} \leq {P}_{bat , disch , max}^{t}\end{matrix} ;$$

wherein T_{bat,min} and T_{bat,max} are minimum and maximum battery operating temperatures respectively,

$${SOC}_{bat}^{t}$$

is an actual charging state of the battery, SOC_{bat,min} and SOC_{bat,max} are upper and lower limits of battery capacity respectively, and

$${P}_{bat , disch , max}^{t}$$

is a maximum battery output power.

Preferably, an air conditioning heat pump objective function in the objective functions of the followers is expressed as:

$$min {I}_{achp} = min ( {\sum }_{t}^{T} ( {P}_{ac}^{t} + {P}_{hp}^{t} + {P}_{ab}^{t} ) / ( {H}_{ac - cabin}^{t} + {H}_{ac - bat}^{t} + {H}_{hp - cabin}^{t} + {H}_{hp - bat}^{t} ) Δ t ) = min ( {\sum }_{t}^{T} ( {P}_{ac}^{t} + {P}_{hp}^{t} + {P}_{ab}^{t} ) / ( {H}_{ac}^{t} + {H}_{hp}^{t} ) Δ t ) ;$$

wherein

$${P}_{ac}^{t} and {P}_{hp}^{t}$$

are cooling and heating power consumptions of the air conditioning heat pump respectively,

$${P}_{ab}^{t}$$

is a blower power consumption,

$${H}_{ac}^{t} and {H}_{hp}^{t}$$

are cooling and heating powers of the air conditioning heat pump respectively, and

$${H}_{ac - cabin}^{t} , {H}_{ac - bat}^{t} , {H}_{hp - cabin}^{t} and {H}_{hp - bat}^{t}$$

are powers of the air conditions heat pump for cooling the passenger cabin, cooling the battery, heating the passenger cabin, and heating the battery, respectively.

Preferably, the Stackelberg equilibrium is expressed as:

$$\{ \begin{matrix}{I}_{er} ( {s}_{er}^{*} , {s}_{bat}^{*} , {s}_{cabin}^{*} , {s}_{achp}^{*} ) \leq {I}_{er} ( {s}_{er} , {s}_{bat}^{*} , {s}_{cabin}^{*} , {s}_{achp}^{*} ) \\ {I}_{cabin} ( {s}_{er}^{*} , {s}_{bat}^{*} , {s}_{cabin}^{*} , {s}_{achp}^{*} ) \leq {I}_{cabin} ( {s}_{er}^{*} , {s}_{bat} , {s}_{cabin}^{*} , {s}_{achp}^{*} ) \\ {I}_{bat} ( {s}_{er}^{*} , {s}_{bat}^{*} , {s}_{cabin}^{*} , {s}_{achp}^{*} ) \leq {I}_{bat} ( {s}_{er}^{*} , {s}_{bat}^{*} , {s}_{cabin} , {s}_{achp}^{*} ) \\ {I}_{achp} ( {s}_{er}^{*} , {s}_{bat}^{*} , {s}_{cabin}^{*} , {s}_{achp}^{*} ) \leq {I}_{achp} ( {s}_{er}^{*} , {s}_{bat}^{*} , {s}_{cabin}^{*} , {s}_{achp} )\end{matrix} ;$$

wherein Iₑᵣ, I_{cabin}, I_{bat}, I_{achp} are the objective functions of the vehicle energy management system, the passenger cabin, the battery, and the air conditioning heat pump, respectively; and

$${s}_{er}^{*} , {s}_{cabin}^{*} , {s}_{bat}^{*} , {s}_{achp}^{*}$$

are optimized strategy sets of the vehicle energy management system, the passenger cabin, the battery, and the air conditioning heat pump, respectively.

The present invention also provides an electro-thermal cooperative control system for an electric vehicle, comprising:
a data acquisition module for acquiring operating state parameters of electric system equipment and thermal system equipment of the electric vehicle; and
a cooperative control module for according to the operating state parameters, adopting Stackelberg competition to obtain next moment operating parameters of the electric system equipment and the thermal system equipment, so as to realize electro-thermal cooperative control of the electric vehicle;
wherein in the Stackelberg competition, a vehicle energy management system is a leader; and a passenger cabin, a battery and an air conditioning heat pump are followers; the vehicle energy management system sends an optimization strategy to the followers in accordance with an objective function of the vehicle energy management system; the followers make decisions in accordance with the optimization strategy sent by the leader, wherein the optimization strategy sent by the leader is used as a constraint, and the followers calculate an optimized strategy according to objective functions of the followers; the optimized strategy is then fed back to the leader; when Stackelberg equilibrium is reached after iterations, the leader and the followers obtain an optimal strategy, so as to obtain the next moment operating parameters of the electric system equipment and the thermal system equipment.

The present invention also provides an Energy-Hub for an electric vehicle, comprising: a device interface unit, a communication center module, and a control center module; wherein the control center module comprises the electro-thermal cooperative control system as mentioned above.

Compared with the prior art, the present invention has the following beneficial effects:

According to the cooperative control method of the present invention, the Stackelberg competition is used to optimize the operating parameters, which enables electro-thermal cooperative control the integrated management for the electric vehicle equipment. Both the overall and local optimizations of vehicle energy allocation are considered, so as to improve the performance of the entire vehicle. Specifically, by using game theory to optimize energy management, the vehicle energy management system, as a leader, ensures that the vehicle is always in the optimal state of driving range. The followers calculate the optimized strategy according to the Energy-Hub strategy, and then the optimized strategy is fed back to the Energy-Hub. After reaching the Stackelberg equilibrium, the current round of the game will be over, and the follower will get the optimal strategy. The game theory optimizes the energy interaction process and improves the energy utilization efficiency.

According to the present invention, an intelligent optimization algorithm is used to solve the equations established in the gaming process, which is fast converging and robust, so that the gaming strategy can be output faster and better, thus achieving the purpose of real-time optimization. It is ensured that the equipment operates normally and saves energy, and then an operating state of the vehicle with the lowest energy consumption is found out under the prerequisite of guaranteeing that all the functions of the whole vehicle are satisfying.

According to the present invention, the objective function of the whole vehicle energy management system takes into account the range indicator of the electric vehicle, so as to optimize the vehicle energy management, thereby improving the performance and effect of the electric vehicle. The passenger cabin objective function determines the temperature control strategy of the passenger cabin by calculating a deviation value between the real-time passenger cabin temperature and the optimal human thermal comfort temperature, so as to ensure the precision and stability of the passenger cabin temperature as well as the demand for human thermal comfort. The battery objective function considers the battery efficiency and the battery electric power output. At the same time, the battery is subject to the condition constraints of its own equipment, such as the temperature, the upper and lower limits of capacity, etc. By considering these condition constraints, the safety and stability of the battery can be ensured and the charging and discharging power of the battery can be optimized during the electro-thermal cooperative control, so as to achieve a better dynamic energy management effect. The air conditioning heat pump objective function calculates the cooling and heating power consumption of the air conditioning heat pump equipment, so that the energy utilization efficiency of the air conditioning heat pump can be optimized. In summary, the objective functions disclosed in the present invention play a key role in both electro-thermal cooperative control and performance improvement, which achieve dynamic energy management and electro-thermal cooperative optimization by integrally considering factors such as the energy demand of the various components and equipment of the electric vehicle, the temperature control requirements, and the thermal comfort of the human body, so as to improve the energy utilization efficiency and performance of the entire vehicle.

### BRIEF DESCRIPTION OF THE DRAWINGS

In order to more clearly illustrate the technical solutions in embodiments of the present invention or prior art, the following is a brief introduction of the accompanying drawings associated with the embodiments or prior art. Obviously, the accompanying drawings are only part of all embodiments of the present invention, and for the person of ordinary skill in the field, other accompanying drawings can be obtained based on these drawings without putting in creative labor.

FIG. 1 is a flow chart of an electro-thermal cooperative control method for an electric vehicle according to an embodiment of the present invention;

FIG. 2 is a schematic diagram showing energy interaction of an Energy-Hub for the electric vehicle according to the embodiment of the present invention;

FIG. 3 is a flow chart of Energy-Hub optimization processes for the electric vehicle according to the embodiment of the present invention; and

FIG. 4 is a schematic diagram of an electro-thermal cooperative control system for the electric vehicle according to the embodiment of the present invention.

### DETAILED DESCRIPTION OF THE PREFERRED EMBODIMENT

In order to enable those skilled in the art to better understand the embodiments of the present invention, technical solutions in the embodiments of the present invention will be described clearly and completely below in conjunction with the accompanying drawings, and it is clear that the described embodiments are only a part of all the embodiments of the present invention. Based on the embodiments described, all other embodiments obtained by a person of ordinary skill in the art without making creative labor shall fall within the protection scope of the present invention.

It should be noted that the terms such as “first” and “second” in the specification and claims of the present invention and the above-described accompanying drawings are used to distinguish between similar objects, and not intended to describe a particular order or sequence. It should be understood that the data so used may be interchanged, where appropriate, so that the embodiments of the present invention described herein can be practiced in an order other than those illustrated or described herein. In addition, the terms “comprising” and “having”, and any variations thereof, are intended to cover non-exclusive embodiments, e.g., a process, method, system, product or apparatus comprising a series of steps or units is not limited to those steps or units clearly listed, but may include those that are not clearly listed or that are inherent to such process, method, product or device.

Referring to the drawings, the present invention will be further illustrated as follows.

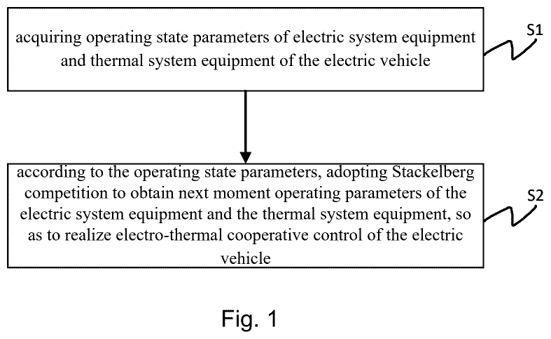

Referring to FIG. 1 of the drawings, an electro-thermal cooperative control method for an electric vehicle according to an embodiment of the present invention is provided, comprising steps of:
step 1: acquiring operating state parameters of electric system equipment and thermal system equipment of the electric vehicle; and
step 2: according to the operating state parameters obtained in the step 1, adopting Stackelberg competition to obtain next moment operating parameters of the electric system equipment and the thermal system equipment, so as to realize electro-thermal cooperative control of the electric vehicle;
wherein in the Stackelberg competition, a vehicle energy management system is a leader; and a passenger cabin, a battery and an air conditioning heat pump are followers; the vehicle energy management system sends an optimization strategy to the followers in accordance with an objective function of the vehicle energy management system; the followers make decisions in accordance with the optimization strategy sent by the leader, wherein the optimization strategy sent by the leader is used as a constraint, and the followers calculate an optimized strategy according to objective functions of the followers; the optimized strategy is then fed back to the leader; when Stackelberg equilibrium is reached after iterations, the leader and the followers obtain an optimal strategy, so as to obtain the next moment operating parameters of the electric system equipment and the thermal system equipment.

According to the technical solution provided by the embodiments of the present invention, the method optimizes energy management using game theory, which enables electro-thermal cooperative energy management of the electric vehicle. With electro-thermal cooperative management, both the overall and local optimizations of vehicle energy allocation are considered, so as to improve the performance of the entire vehicle.

According to the embodiment of the present invention, an Energy-Hub for an electric vehicle is provided, comprising: a device interface unit, a communication center module, and a control center module; wherein
the device interface unit is used for accessing preset electric vehicle devices; the communication center module is used for collecting information of the preset electric vehicle devices, obtaining current operating state parameters of the devices, and identifying load types; the control center module is used for optimizing and calculating the electric system and the thermal system according to the obtained operating state parameters, and outputting a strategy to regulate the operating parameters of the equipment at the next moment.

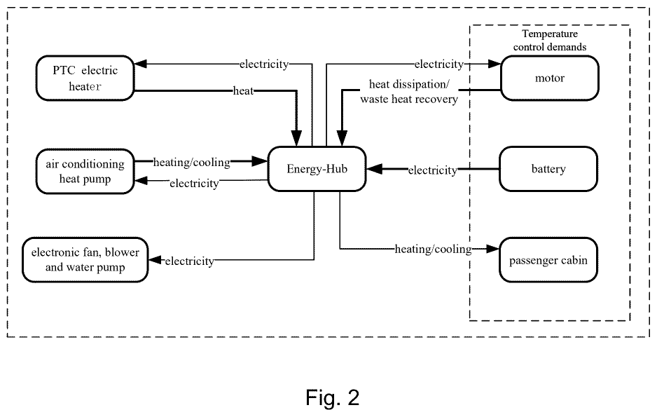

FIG. 2 is a schematic diagram showing energy interaction of an Energy-Hub for the electric vehicle according to the embodiment of the present invention. In terms of electricity utilization, the electric motor control, the air conditioning heat pump, the PTC electric heating, the blower, the electric fan, and the water pump all need to draw electricity from the battery. In terms of heating and cooling, the air conditioning heat pump can be used to heat the passenger cabin and the battery, and the residual heat of the motor electric control can be used to heat the passenger cabin. The air conditioning heat pump can also be used to cool the passenger cabin and the battery. Under the premise of satisfying electric load, heat load and cold load, the Energy-Hub can calculate the optimal program and flexibly manage the dynamic energy. More specifically, according to the embodiment of the present invention, for the controllable electrical load, the motor electric control, the air conditioning heat pump, the PTC electric heating, the blower, the electronic fan, and the water pump can switch between different working modes according to the instruction from the control center; for the controllable heating and cooling load, the passenger cabin and the battery have the demands for heating and cooling, and the motor electric control has the demand for heat dissipation. Under a cooling mode, the air conditioning heat pump to cool the the passenger cabin and the battery; and under a heating mode, the air conditioning heat pump heats the passenger cabin and the battery. The PTC electric heating can also be used for heating the passenger cabin and the battery, and the waste heat recovery of the motor electric control can be used for heating the passenger cabin. According to the instructions from the control center, temperatures of the passenger cabin, the battery and the motor electric control can be regulated. Under the premise of safe temperatures of the motor electric control and the battery, the Energy-Hub can calculate the optimal strategy and manage the dynamic energy flexibly.

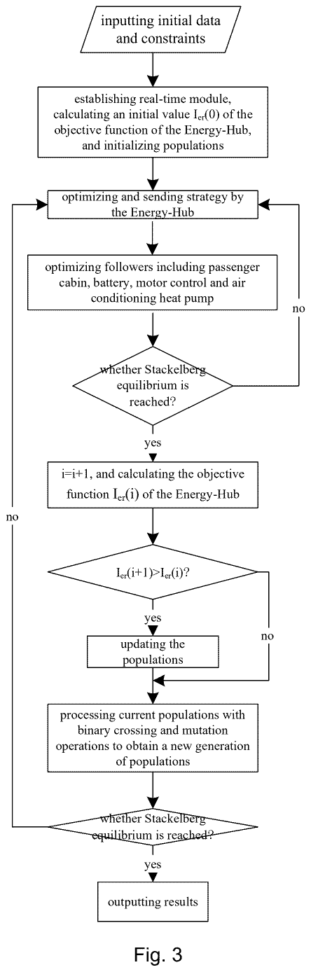

Referring to FIG. 3, according to the embodiment of the present invention, during optimizing and calculating the electric system and thermal system according to the obtained operating state parameters to regulate the next moment operating parameters of the equipment with an output strategy, the control strategy is to adopt the Stackelberg competition for the Energy-Hub, the equipment and the passenger cabin of the electric vehicle. The Energy-Hub is the leader; and the passenger cabin, the battery and the air conditioning heat pump are the followers. The strategies obtained from the game comprises battery charging and discharging powers, a motor power consumption, an air conditioning power consumption, a PTC power consumption, a blower power consumption, an electronic fan power consumption, a water pump power consumption, a battery temperature curve, and a passenger cabin temperature curve. The participants establish their own objective functions, containing a range index of the vehicle, a temperature index of the temperature control components, and a performance index of the main components. When the Stackelberg equilibrium is reached, the leader and the followers obtain the optimal strategy, and the Stackelberg equilibrium is expressed as:

$$\{ \begin{matrix}{I}_{er} ( {s}_{er}^{*} , {s}_{bat}^{*} , {s}_{cabin}^{*} , {s}_{achp}^{*} ) \leq {I}_{er} ( {s}_{er} , {s}_{bat}^{*} , {s}_{cabin}^{*} , {s}_{achp}^{*} ) \\ {I}_{cabin} ( {s}_{er}^{*} , {s}_{bat}^{*} , {s}_{cabin}^{*} , {s}_{achp}^{*} ) \leq {I}_{cabin} ( {s}_{er}^{*} , {s}_{bat} , {s}_{cabin}^{*} , {s}_{achp}^{*} ) \\ {I}_{bat} ( {s}_{er}^{*} , {s}_{bat}^{*} , {s}_{cabin}^{*} , {s}_{achp}^{*} ) \leq {I}_{bat} ( {s}_{er}^{*} , {s}_{bat}^{*} , {s}_{cabin} , {s}_{achp}^{*} ) \\ {I}_{achp} ( {s}_{er}^{*} , {s}_{bat}^{*} , {s}_{cabin}^{*} , {s}_{achp}^{*} ) \leq {I}_{achp} ( {s}_{er}^{*} , {s}_{bat}^{*} , {s}_{cabin}^{*} , {s}_{achp}^{*} )\end{matrix} ;$$

wherein Iₑᵣ, I_{cabin}, I_{bat}, I_{achp} are the objective functions of the vehicle energy management system, the passenger cabin, the battery, and the air conditioning heat pump, respectively; and

$${s}_{er}^{*} , {s}_{cabin}^{*} , {s}_{bat}^{*} , {s}_{achp}^{*}$$

are optimized strategy sets of the vehicle energy management system, the passenger cabin, the battery, and the air conditioning heat pump, respectively.

According to the embodiment of the present invention, the optimization and calculation of the Stackelberg competition comprise inputting initial data and constraints, inputting initial parameters such as weather and intersection parameters, and inputting operating parameters of each equipment; calculating an initial value Iₑᵣ (0) of the objective function of the Energy-Hub, and initializing power and temperature populations using an NSGA II algorithm; selecting the power and temperature populations by the leader and sending the optimization strategy to the followers; calculating optimized strategy sets according to the objective functions of the followers, and selecting an optimal solution from the optimal strategy sets by using a TOPSIS method, and then feeding the optimized strategy back to the leader; after reaching the Stackelberg equilibrium, calculating the objective function of the vehicle energy management system Iₑᵣ (i); processing the power and temperature populations with binary crossing and mutation operations, and obtaining a new generation of populations by an elite strategy; and optimizing the Stackelberg competition again, and calculating a new objective function of the vehicle energy management system; if Iₑᵣ (i+1)>Iₑᵣ (i), then updating the populations, otherwise keeping the populations unchanged; then determining whether the Stackelberg equilibrium is reached; if yes, outputting results, otherwise repeating the iterations;

$$max {I}_{er} = max {\sum }_{t}^{T} S ( {P}_{bat , disch}^{t} , {T}_{bat}^{t} , v , {η}_{bat} ) Δ t ;$$

wherein Iₑᵣ is a range indicator of the electric vehicle, S is a driving range,

$${P}_{bat , disch}^{t}$$

is a battery output power,

$${T}_{bat}^{t}$$

is a battery temperature, v is a vehicle speed, η_{bat} is a battery working efficiency, Δt is a preset time interval, and T is a scheduling cycle.

According to the embodiment of the present invention, the passenger cabin aims to minimize the deviation and fluctuation between the actual passenger cabin temperature and the optimal thermal comfort temperature within one scheduling cycle. A passenger cabin objective function I_{cabin} is expressed as:

$$min {I}_{cabin} = min {\sum }_{t}^{T} {φ}_{cabin} ( {T}_{cabin}^{t} - {T}_{cabin , set} ) + {{ϕ}_{cabin} ( {T}_{cabin}^{t} - {T}_{cabin , set} )}^{2} Δ t ;$$

wherein T_{cabin,set} is an optimal thermal comfort temperature; φ_{cabin} and φ_{cabin} are a temperature deviation coefficient and a temperature fluctuation coefficient, respectively;

According to the embodiment of the present invention, the PMV for the optimal thermal comfort temperature of the passenger cabin is 0, which is expressed as:

$${T}_{cabin , set} = {t}_{a} {\vert}_{PMV = 0} ;$$

$$PMV = [ 0.303 {e}^{- 0.036 M} + 0.028 ] \times \{ M - W - ( {φ}_{1} + {φ}_{2} + {φ}_{3} + {φ}_{4} + {φ}_{5} + {φ}_{6} ) ;$$

$$\{ \begin{matrix}{φ}_{1} = 3.05 \times [ 5.733 - 0.007 ( M - W ) - {P}_{a} \\ {φ}_{2} = - 0.42 ( M - W - 58.2 ) \\ {φ}_{3} = 0.017 M ( 5.867 - {P}_{a} ) \\ {φ}_{4} = 0.0014 M ( 34 - {t}_{a} ) \\ {φ}_{5} = 3.96 \times {10}^{- 8} {f}_{cl} [ {( {t}_{cl} + 273 )}^{4} - {( \overline{{t}_{r}} + 273 )}^{4} ] \\ {φ}_{6} = {f}_{cl} {h}_{c} ( {t}_{cl} - {t}_{a} ) \\ {t}_{cl} = 3.57 - 0.028 * ( M - W ) - 0.155 {I}_{cl} ( {φ}_{5} + {φ}_{6} )\end{matrix} ;$$

wherein tₐ is an air temperature around a passenger, M is an energy metabolic rate of the passenger, W is a mechanical work done by the passenger, t_{cl} is a surface temperature of clothing, t̅ᵣ̅ is an average radiant temperature in the passenger cabin, Pₐ is a partial pressure of water vapor around the passenger, h_{c} is a convective heat transfer coefficient, ƒ_{cl} is a clothing area coefficient, and I_{cl} is a clothing thermal resistance.

According to the embodiment of the present invention, a battery objective function I_{bat} comprises the highest battery operating efficiency and the lowest energy consumption of the power consuming components that draw power from the battery, which is expressed as:

$$min {I}_{bat} = min {\sum }_{t}^{T} [ {a}_{2} {P}_{bat , disch}^{t} - {a}_{2} {f}_{η} ( {T}_{bat}^{t} ) ] Δ t ;$$

wherein ƒ_{η} is a battery efficiency function, which is related to the battery temperature

$${T}_{bat}^{t} ; {P}_{bat , disch}^{t}$$

is the battery output power, a₁ and a₂ are weighting coefficients;
wherein an equipment condition constraint for the battery is expressed as:

$$\{ \begin{matrix}{T}_{bat , min} \leq {T}_{bat}^{t} \leq {T}_{bat , max} \\ {SOC}_{bat , min} \leq {SOC}_{bat}^{t} \leq {SOC}_{bat , max} \\ {P}_{bat , disch}^{t} \leq {P}_{bat , disch , max}^{t}\end{matrix} ;$$

wherein I_{bat,min} and T_{bat,max} are minimum and maximum battery operating temperatures respectively,

$${SOC}_{bat}^{t}$$

is an actual charging state of the battery, SOC_{bat,min} and SOC_{bat,max} are upper and lower limits of battery capacity respectively, and

$${P}_{bat , disch , max}^{t}$$

is a maximum battery output power.

According to the embodiment of the present invention, an air conditioning heat pump objective function is expressed as:

$$min {I}_{achp} = min ( {\sum }_{t}^{T} ( {P}_{ac}^{t} + {P}_{hp}^{t} + {P}_{ab}^{t} ) / ( {H}_{ac - cabin}^{t} + {H}_{ac - bat}^{t} + {H}_{hp - cabin}^{t} + {H}_{hp - bat}^{t} ) Δ t ) = min ( {\sum }_{t}^{T} ( {P}_{ac}^{t} + {P}_{hp}^{t} + {P}_{ab}^{t} ) / ( {H}_{ac}^{t} + {H}_{hp}^{t} ) Δ t ) ;$$

wherein

$${P}_{ac}^{t} and {P}_{hp}^{t}$$

are cooling and heating power consumptions of the air conditioning heat pump respectively,

$${P}_{ab}^{t}$$

is a blower power consumption,

$${H}_{ac}^{t} and {H}_{hp}^{t}$$

are cooling and heating powers of the air conditioning heat pump respectively, and

$${H}_{ac - cabin}^{t} , {H}_{ac - bat}^{t} , {H}_{hp - cabin}^{t} and {H}_{hp - bat}^{t}$$

are powers of the air conditioning heat pump for cooling the passenger cabin, cooling the battery, heating the passenger cabin, and heating the battery, respectively. The air conditioning heat pump objective function considers the minimum joint energy consumption of the air conditioning heat pump and the blower under the unit cooling capacity and the unit heating capacity.

According to the embodiment of the present invention, power balance constraints to be satisfied when solving each of the above objective functions are as follows:

$$electrical power balance is {P}_{mot}^{t} + {P}_{ecu}^{t} + {P}_{ab}^{t} + {P}_{ef}^{t} + {P}_{wp}^{t} + {P}_{ac}^{t} + {P}_{hp}^{t} = {P}_{bat , disch}^{t} ;$$

$$thermal power balance is {H}_{cabin}^{t} + {H}_{bat}^{t} = {COP}_{h} {P}_{hp}^{t} + {η}_{ptc} {P}_{ptc}^{t} + {H}_{mot - cabin}^{t} + {H}_{ecu - cabin}^{t} ;$$

$$cooling power balance is {H}_{ac - bat}^{t} + {H}_{ac - cabin}^{t} = {COP}_{c} {P}_{ac}^{t} ;$$

wherein

$${P}_{mot}^{t} , {P}_{ecu}^{t} , {P}_{ab}^{t} , {P}_{ef}^{t} and {P}_{wp}^{t}$$

are power consumptions of the motor, the electronic controller, the electronic fan, the blower and the water pump, respectively; COPₕ and COP_{c} are heating and cooling energy efficiency ratios of the air conditioning heat pump, respectively; η_{ptc} is PTC electric heating efficiency;

$${P}_{ptc}^{t}$$

is a power consumption of the PTC electric heating;

$${H}_{mot - cabin}^{t} and {H}_{ecu - cabin}^{t}$$

are heating powers of motor and electric waste heat recovery for the passenger cabin, respectively.

According to the embodiment of the present invention, the Energy-Hub for the electric vehicle can cooperatively manage the electric system and thermal system of the electric vehicle. The integrated electric management module and thermal management module can realize the electro-thermal integrated management. By using game theory to optimize energy management, the Energy-Hub, as a leader, ensures that the whole vehicle is always in the optimal state of driving range. The followers, namely the passenger cabin, the battery, and the air conditioning heat pump, will also get the optimal strategy. The game theory optimizes the energy interaction process and improves the energy utilization efficiency. An intelligent optimization algorithm is used to solve the equations established in the gaming process, which is simple in structure, fast converging and robust, so that the gaming strategy can be output faster and better, thus achieving the purpose of real-time optimization.

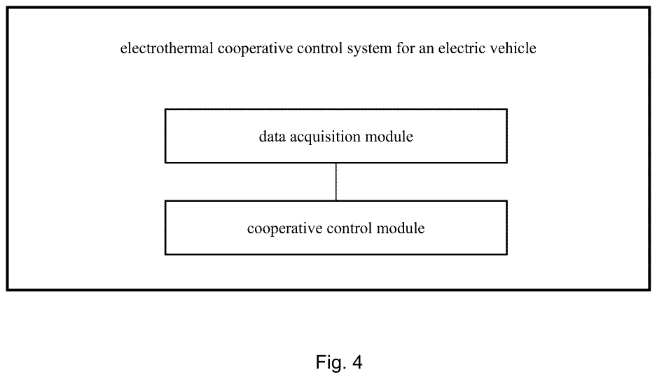

Referring to the FIG. 4, an electro-thermal cooperative control system for an electric vehicle according to the embodiment of the present invention is provided, comprising:
a data acquisition module for acquiring operating state parameters of electric system equipment and thermal system equipment of the electric vehicle; and
a cooperative control module for according to the operating state parameters, adopting Stackelberg competition to obtain next moment operating parameters of the electric system equipment and the thermal system equipment, so as to realize electro-thermal cooperative control of the electric vehicle;
wherein in the Stackelberg competition, a vehicle energy management system is a leader; and a passenger cabin, a battery and an air conditioning heat pump are followers; the vehicle energy management system sends an optimization strategy to the followers in accordance with an objective function of the vehicle energy management system; the followers make decisions in accordance with the optimization strategy sent by the leader, wherein the optimization strategy sent by the leader is used as a constraint, and the followers calculate an optimized strategy according to objective functions of the followers; the optimized strategy is then fed back to the leader; when Stackelberg equilibrium is reached after iterations, the leader and the followers obtain an optimal strategy, so as to obtain the next moment operating parameters of the electric system equipment and the thermal system equipment.

It should be clear to those skilled in the art that the implementation of the present application may be provided as methods, systems, or computer program products. Thus, the present application may take the form of a fully hardware embodiment, a fully software embodiment, or an embodiment that combines software and hardware aspects. Furthermore, the present application may take the form of a computer program product implemented on one or more computer-readable storage media (such as disk memory, CD-ROM, optical memory, and the like) that contain computer-readable program code therein.

The present invention is described with reference to flowcharts and/or block diagrams of methods, devices (systems), and computer program products according to the embodiments. It should be understood that each of the processes and/or boxes in the flowchart and/or block diagram, and the combination thereof, may be implemented by computer program instructions. These computer program instructions may be provided to a processor of a general-purpose computer, a special-purpose computer, an embedded processor, or other programmable data-processing device to produce a machine such that the instructions executed by the processor of the computer or other programmable data-processing device produce a device for carrying out the functions specified in one process or multiple processes of the flowchart and/or one box or multiple boxes of the block diagram.

These computer program instructions may also be stored in computer-readable memory that capable of directing the computer or other programmable data processing device to operate in a particular manner such that the instructions stored in the computer-readable memory produce an article of manufacture comprising an instruction device that implements the function specified in one process or multiple processes of the flowchart and/or one box or multiple boxes of the block diagram.

These computer program instructions may also be loaded onto a computer or other programmable data processing device such that a series of operational steps are performed on the computer or other programmable device to produce computer-implemented processing, such that the instructions executed on the computer or other programmable device provide steps for implementing the function specified in one process or multiple processes of the flowchart and/or one box or multiple boxes of the block diagram.

Finally, it should be noted that the above embodiments are only used to illustrate the technical solution of the present invention and are not limiting. Although the present invention has been described in detail with reference to the above embodiments, a person of ordinary skill in the art should understand that the specific embodiments of the present invention can still be modified or equivalently replaced, and that any modification or equivalent replacement that does not depart from the spirit and scope of the present invention shall be covered by the protection scope of the following claims.

What is claimed is:

1. An electro-thermal cooperative control method for an electric vehicle, comprising steps of:
acquiring operating state parameters of electric system equipment and thermal system equipment of the electric vehicle; and
according to the operating state parameters, adopting Stackelberg competition to obtain next moment operating parameters of the electric system equipment and the thermal system equipment, so as to realize electro-thermal cooperative control of the electric vehicle;
wherein in the Stackelberg competition, a vehicle energy management system is a leader; and a passenger cabin, a battery and an air conditioning heat pump are followers; the vehicle energy management system sends an optimization strategy to the followers in accordance with an objective function of the vehicle energy management system; the followers make decisions in accordance with the optimization strategy sent by the leader, wherein the optimization strategy sent by the leader is used as a constraint, and the followers calculate an optimized strategy according to objective functions of the followers; the optimized strategy is then fed back to the leader; when Stackelberg equilibrium is reached after iterations, the leader and the followers obtain an optimal strategy, so as to obtain the next moment operating parameters of the electric system equipment and the thermal system equipment.

2. The electro-thermal cooperative control method, as recited in claim 1, wherein in the step of acquiring the operating state parameters of the electric system equipment and the thermal system equipment of the electric vehicle:
the electric system equipment comprises the battery, a motor, and an electronic controller; and
the thermal system equipment comprises the air conditioning heat pump, a PTC (positive-temperature-coefficient) electric heater, an electronic fan, a blower, a water pump, and a motor electric waste heat recovery device.

3. The electro-thermal cooperative control method, as recited in claim 1, wherein in the step of according to the operating state parameters, adopting the Stackelberg competition to obtain the next moment operating parameters of the electric system equipment and the thermal system equipment:
the Stackelberg competition is adopted to obtain the next moment operating parameters comprising battery charging and discharging powers, a motor power consumption, an air conditioning power consumption, an electric heating PTC power consumption, a blower power consumption, an electronic fan power consumption, a water pump power consumption, a battery temperature curve, and a passenger cabin temperature curve.

4. The electro-thermal cooperative control method, as recited in claim 1, wherein the step of according to the operating state parameters, adopting the Stackelberg competition to obtain the next moment operating parameters of the electric system equipment and the thermal system equipment, so as to realize the electro-thermal cooperative control of the electric vehicle, comprises specific steps of:
calculating an initial value of the objective function of the vehicle energy management system, and initializing power and temperature populations using an NSGA (Non-dominated Sorting Genetic Algorithm) II algorithm;
selecting the power and temperature populations by the leader and sending the optimization strategy to the followers; calculating optimized strategy sets according to the objective functions of the followers, and selecting an optimal solution from the optimal strategy sets by using a TOPSIS (Technique for Order of Preference by Similarity to Ideal Solution) method, and then feeding the optimized strategy back to the leader; after reaching the Stackelberg equilibrium, calculating the objective function of the vehicle energy management system Iₑᵣ (i); processing the power and temperature populations with binary crossing and mutation operations, and obtaining a new generation of populations by an elite strategy; and
optimizing the Stackelberg competition again, and calculating a new objective function of the vehicle energy management system Iₑᵣ (i+1); if Iₑᵣ (i+1)>Iₑᵣ (i), then updating the populations, otherwise keeping the populations unchanged; then determining whether the Stackelberg equilibrium is reached; if yes, outputting results, otherwise repeating the iterations;
wherein the objective function of the vehicle energy management system is expressed as:
$$max {I}_{er} = max {\sum }_{t}^{T} S ( {P}_{bat , disch}^{t} , {T}_{bat}^{t} , v , {η}_{bat} ) Δ t ;$$
wherein Iₑᵣ is a range indicator of the electric vehicle, S is a driving range,
$${P}_{bat , disch}^{t}$$
is a battery output power,
$${T}_{bat}^{t}$$
is a battery temperature, v is a vehicle speed, η_{bat} is a battery working efficiency, Δt is a preset time interval, and Tis a scheduling cycle.

5. The electro-thermal cooperative control method, as recited in claim 4, wherein a passenger cabin objective function I_{cabin} in the objective functions of the followers is expressed as:
$$min {I}_{cabin} = min {\sum }_{t}^{T} {φ}_{cabin} ( {T}_{cabin}^{t} - {T}_{cabin , set} ) + {{ϕ}_{cabin} ( {T}_{cabin}^{t} - {T}_{cabin , set} )}^{2} Δ t ;$$
wherein T_{cabin} is a real-time passenger cabin temperature and t denotes time; T_{cabin,set} is an optimal thermal comfort temperature; φ_{cabin} and φ_{cabin} are a temperature deviation coefficient and a temperature fluctuation coefficient, respectively;
wherein when thermal comfort PMV (Predicted Mean Vote) is close to 0, then a temperature is more comforting, and the PMV for the optimal thermal comfort temperature of the passenger cabin is 0, which is expressed as:
$${T}_{cabin , set} = {t}_{a} {\vert}_{PMV = 0} ;$$
$$PMV = [ 0.303 {e}^{- 0.036 M} + 0.028 ] \times \{ M - W - ( {φ}_{1} + {φ}_{2} + {φ}_{3} + {φ}_{4} + {φ}_{5} + {φ}_{6} ) ;$$
$$\{ \begin{matrix}{φ}_{1} = 3.05 \times [ 5.733 - 0.007 ( M - W ) - {P}_{a} \\ {φ}_{2} = - 0.42 ( M - W - 58.2 ) \\ {φ}_{3} = 0.017 M ( 5.867 - {P}_{a} ) \\ {φ}_{4} = 0.0014 M ( 34 - {t}_{a} ) \\ {φ}_{5} = 3.96 \times {10}^{- 8} {f}_{cl} [ {( {t}_{cl} + 273 )}^{4} - {( \overline{{t}_{r}} + 273 )}^{4} ] \\ {φ}_{6} = {f}_{cl} {h}_{c} ( {t}_{cl} - {t}_{a} ) \\ {t}_{cl} = 35.7 - 0.028 * ( M - W ) - 0.155 {I}_{cl} ( {φ}_{5} + {φ}_{6} )\end{matrix} ;$$
wherein tₐ is an air temperature around a passenger, Mis an energy metabolic rate of the passenger, W is a mechanical work done by the passenger, t_{cl} is a surface temperature of clothing, t̅ᵣ̅ is an average radiant temperature in the passenger cabin, Pₐ is a partial pressure of water vapor around the passenger, h_{c} is a convective heat transfer coefficient, ƒ_{cl} is a clothing area coefficient, and I_{cl} is a clothing thermal resistance.

6. The electro-thermal cooperative control method, as recited in claim 4, wherein a battery objective function I_{bat} in the objective functions of the followers is expressed as:
$$max {I}_{bat} = max {\sum }_{t}^{T} [ {a}_{1} {f}_{η} ( {T}_{bat}^{t} ) - {a}_{2} {P}_{bat , disch}^{t} ] Δ t ;$$
wherein ƒ_{η} is a battery efficiency function,
$${P}_{bat , disch}^{t}$$
is the battery output power, a₁ and a₂ are weighting coefficients;
wherein an equipment condition constraint for the battery is expressed as:
$$\{ \begin{matrix}{T}_{bat , min} \leq {T}_{bat}^{t} \leq {T}_{bat , max} \\ {SOC}_{bat , min} \leq {SOC}_{bat}^{t} \leq {SOC}_{bat , max} \\ {P}_{bat , disch}^{t} \leq {P}_{bat , disch , max}^{t}\end{matrix} ;$$
wherein T_{bat,min} and T_{bat,max} are minimum and maximum battery operating temperatures respectively,
$${SOC}_{bat}^{t}$$
is an actual charging state of the battery, SOC_{bat,min} and SOC_{bat,max} are upper and lower limits of battery capacity respectively, and
$${P}_{bat , disch , max}^{t}$$
is a maximum battery output power.

7. The electro-thermal cooperative control method, as recited in claim 4, wherein an air conditioning heat pump objective function in the objective functions of the followers is expressed as:
$$min {I}_{achp} = min ( {\sum }_{t}^{T} ( {P}_{ac}^{t} + {P}_{hp}^{t} + {P}_{ab}^{t} ) / ( {H}_{ac - cabin}^{t} + {H}_{ac - bat}^{t} + {H}_{hp - cabin}^{t} + {H}_{hp - bat}^{t} ) Δ t ) = min ( {\sum }_{t}^{T} ( {P}_{ac}^{t} + {P}_{hp}^{t} + {P}_{ab}^{t} ) / ( {H}_{ac}^{t} + {H}_{hp}^{t} ) Δ t ) ;$$
wherein
$${P}_{ac}^{t} and {P}_{hp}^{t}$$
are cooling and heating power consumptions of the air conditioning heat pump respectively,
$${P}_{ab}^{t}$$
is a blower power consumption,
$${H}_{ac}^{t} and {H}_{hp}^{t}$$
are cooling and heating powers of the air conditioning heat pump respectively, and
$${H}_{ac - cabin}^{t} , {H}_{ac - bat}^{t} , {H}_{hp - cabin}^{t} and {H}_{hp - bat}^{t}$$
are powers of the air conditioning heat pump for cooling the passenger cabin, cooling the battery, heating the passenger cabin, and heating the battery, respectively.

8. The electro-thermal cooperative control method, as recited in claim 1, wherein the Stackelberg equilibrium is expressed as:
$$\{ \begin{matrix}{I}_{er} ( {s}_{er}^{*} , {s}_{bat}^{*} , {s}_{cabin}^{*} , {s}_{achp}^{*} ) \leq {I}_{er} ( {s}_{er} , {s}_{bat}^{*} , {s}_{cabin}^{*} , {s}_{achp}^{*} ) \\ {I}_{cabin} ( {s}_{er}^{*} , {s}_{bat}^{*} , {s}_{cabin}^{*} , {s}_{achp}^{*} ) \leq {I}_{cabin} ( {s}_{er}^{*} , {s}_{bat} , {s}_{cabin}^{*} , {s}_{achp}^{*} ) \\ {I}_{bat} ( {s}_{er}^{*} , {s}_{bat}^{*} , {s}_{cabin}^{*} , {s}_{achp}^{*} ) \leq {I}_{bat} ( {s}_{er}^{*} , {s}_{bat}^{*} , {s}_{cabin} , {s}_{achp}^{*} ) \\ {I}_{achp} ( {s}_{er}^{*} , {s}_{bat}^{*} , {s}_{cabin}^{*} , {s}_{achp}^{*} ) \leq {I}_{achp} ( {s}_{er}^{*} , {s}_{bat}^{*} , {s}_{cabin}^{*} , {s}_{achp} )\end{matrix} ;$$
wherein Iₑᵣ, I_{cabin}, I_{bat}, I_{achp} are the objective functions of the vehicle energy management system, the passenger cabin, the battery, and the air conditioning heat pump, respectively; and
$${s}_{er}^{*} , {s}_{cabin}^{*} , {s}_{bat}^{*} , {s}_{achp}^{*}$$
are optimized strategy sets of the vehicle energy management system, the passenger cabin, the battery, and the air conditioning heat pump, respectively.

9. An electro-thermal cooperative control system for an electric vehicle, comprising:
a data acquisition module for acquiring operating state parameters of electric system equipment and thermal system equipment of the electric vehicle; and
a cooperative control module for according to the operating state parameters, adopting Stackelberg competition to obtain next moment operating parameters of the electric system equipment and the thermal system equipment, so as to realize electro-thermal cooperative control of the electric vehicle;
wherein in the Stackelberg competition, a vehicle energy management system is a leader; and a passenger cabin, a battery and an air conditioning heat pump are followers; the vehicle energy management system sends an optimization strategy to the followers in accordance with an objective function of the vehicle energy management system; the followers make decisions in accordance with the optimization strategy sent by the leader, wherein the optimization strategy sent by the leader is used as a constraint, and the followers calculate an optimized strategy according to objective functions of the followers; the optimized strategy is then fed back to the leader; when Stackelberg equilibrium is reached after iterations, the leader and the followers obtain an optimal strategy, so as to obtain the next moment operating parameters of the electric system equipment and the thermal system equipment.

10. An Energy-Hub for an electric vehicle, comprising: a device interface unit, a communication center module, and a control center module;
wherein the control center module comprises the electro-thermal cooperative control system as recited in claim 8.
